(19) United States
(12) Patent Application Publication
(10) Pub. No.: US 2003/0233381 A1
(43) Pub. Date: Dec. 18, 2003

(54) File management method

(75) Inventors: Naozumi Sugimura, Yokohama (JP); Taku Hoshizawa, Zushi (JP); Masuo Oku, Kamakura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/301,067

(22) Filed: Nov. 20, 2002

(30) Foreign Application Priority Data
Jun. 13, 2002 (JP) 2002-172199

(51) Int. Cl. G06F 12/00

(52) U.S. Cl. 707/200

(57) ABSTRACT

A main file management area and a sub file management area are provided on a file system. The sub file management area, having sub file management information and plural sub files managed by the sub file management information, is handled as one file on the main file management information. That is, the file where the sub files are defined is managed similarly to main files by the main file management information. As the sub file management information is provided in addition to the main file management information, more files can be managed in comparison with a case where only the main file management information is used. Further, as the sub file management area is handled as one file on the main file, it can be managed without influence on the structure of the main file system.

### BACKGROUND OF THE INVENTION

1. Field of the Invention

The present invention relates to a file management method, and more particularly, to a file management regarding a file structure formed in file format on a random-accessible recording medium such as an optical disk, a magnetic disk or a semiconductor memory, a file system, a file access method and a computer program for file access.

2. Description of the Prior Art

In recording devices such as an optical disk device, a magnet disk device and a magneto-optical disk device, a file system to manage data in file format is employed for facilitation of access to stored data.

As a generally-known optical disk, a CD-ROM (Compact Disc-Read Only Memory) is widely used. Generally, a file system called ISO 9660 is used in the CD-ROM. In the ISO 9660 system, file management is made by using serially-numbered tables called path tables. A 16-bit value is allocated to each table.

On the other hand, in a DVD (Digital Versatile Disc) which is becoming popular as a higher-density optical disk, a file system called UDF (Universal Disc format) is widely used. In the UDF system, file management is made by use of a table of file identifier and entry for each directory.

Further, a file system as disclosed in Japanese Published Unexamined Patent Application No. Hei 11-312378 is known as an AV data recording/reproduction. In the file system, file management is made by using a data management tables such as a file table. As in the case of the above-described ISO 9660, a 16-bit number is allocated to each table for table management.

However, the conventional file systems have the following problems.

In many of the conventional file systems including the ISO 9660, as the table number used in file management is a 16-bit value from 0 to 65535, the maximum number of formable tables is 65536. That is, the number of files which can be managed in the file system is limited to 65536. For example, as a DVD-RAM (Digital Versatile Disc-Random Access Memory) disk has about 2,300,000 sectors as minimum data recording units, the number of manageable files in the file system, 65536, is insufficient in use of this medium.

In recent years, a recording capacity of recording media represented by optical disk and magnetic disk is increasing, and the number of recordable files is also increasing. Even in this situation, file systems which are merely extensions of the conventional file systems are widely used, and a problem described as above occurs when a large capacity disk is used.

On the other hand, as the number of files manageable by the UDF system is the thirty-second power of 2, i.e., four billion or greater, a large number of files can be handled. However, the UDF is not supported by all the devices.

If the file system structure is changed, compatibility with conventional devices is lost. Accordingly, it is difficult to greatly change the file system itself. Especially, in AV (audio visual) devices such as a video disk recorder, software cannot be changed without difficulty, further, data cannot be reproduced from a recording medium with no compatibility with the conventional file system.

Further, personal computers (PCs) tend to handle a large number of files having small data amounts. Generally, in a recording medium such as an optical disk, as a rewritable data recording unit is comparatively large, in recording of a small-data-amount file, the recording area on the recording medium is wasted.

### SUMMARY OF THE INVENTION

The present invention has an object to provide a file system which manages more files while maintaining compatibility with file systems where the number of manageable data files is less than the number of recordable files.

Another object of the present invention is to provide a file management method for managing more files in comparison with a case where only main file management information is used, by providing sub file management information in addition to the main file management information.

Another object of the present invention is to provide a file system preferably applicable to an optical disk medium having a very large number of sectors such as a DVD-RAM.

The file management method according to the present invention, comprises: providing at least two different kinds of information, namely first file management information and second file management information on a file system; and handling the second file management information as a file on the first file management information.

According to the present invention, as the second file (sub file) management information is provided as well as the first file (main file) management information, more files can be managed in comparison with a case where only the main file management information is used. Further, as the sub file system is handled as one file on the main file system, the structure of the main file system is not influenced, and the system has excellent compatibility.

Preferably, the file system is a file structure formed on an optical disk, comprising: a first file system having a first file area for storing plural first files and a first management area for storing first management information managing access to plural files in the first file area; and a second file system having a second file area, using at least one file storage area in the first file area in the first file system, for storing plural second files, and a second management area for storing second management information managing access to plural files in the second file area.

For example, the file structure formed on the optical disk comprises: an anchor descriptor storage area for storing an anchor descriptor indicating information on a position of main file management information; a main file management area for storing the main file management information on storing positions, data sizes and file names of plural main files; a main file area for storing the plural main files; and a sub file area, being a particular area as one file of the plural main files, having a sub file management area for storing sub file management information storing positions, data sizes and file names of plural sub files and a sub file area for storing the plural sub files.

Further, the present invention can be realized as a method for accessing the above file system. The access method is executed by a computer program installed in a server or a memory of a personal computer.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing the logical arrangement of file management information and files in a file system according to the present invention;

FIG. 2 is a diagram showing the structure of unit data;

FIG. 3 is a diagram showing the structure of an ECC block;

FIG. 4 is a diagram showing the structure of main file management information;

FIG. 5 is a diagram showing the arrangement of sub file management information;

FIG. 6 is a block diagram showing an optical disk recording/reproduction apparatus;

FIG. 7 is a flowchart showing a processing operation by a computer program for access to the file system according to the present invention;

FIG. 8 is an explanatory view of additional recording of sub file and sub file management information;

FIG. 9 is a diagram showing the arrangement of the sub file management information;

FIG. 10 is a diagram showing the arrangement of the sub file management information;

FIG. 11 is a diagram showing the arrangement of the sub file management information; and

FIG. 12 is an explanatory view of additional recording of the sub file.

### DETAILED DESCRIPTION OF PREFERRED EMBODIMENTS

Preferred embodiments of the present invention will now be described in detail in accordance with the accompanying drawings.

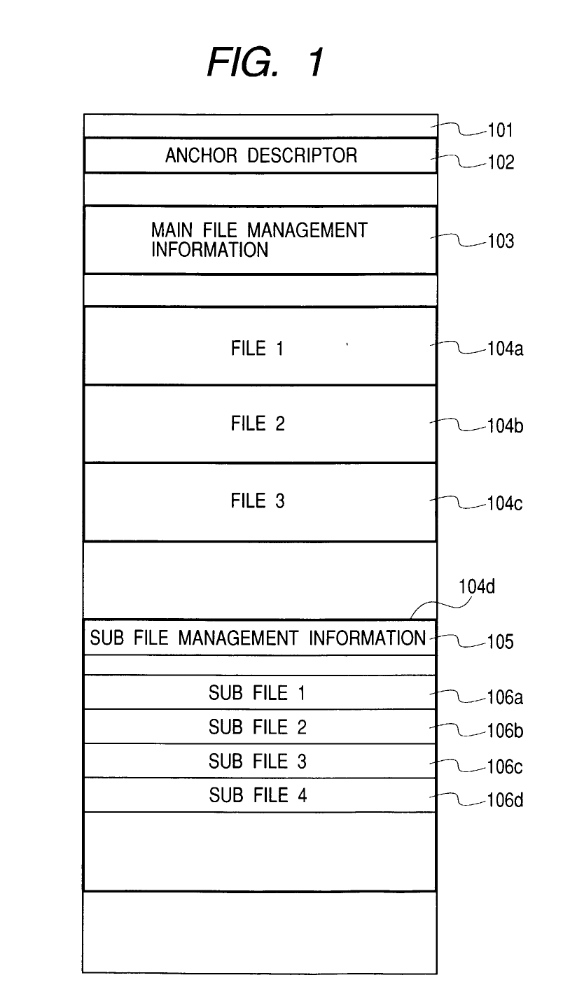

FIG. 1 shows the logical arrangement of file management information and files in a file system according to the present invention. The physical arrangement i.e. the arrangement on a recording medium is not limited to the order shown in FIG. 1, however, it is more preferable to record in the order shown in FIG. 1 in order to reduce access time. In the present embodiment, the logical arrangement and the physical arrangement are the same for convenience of explanation. Further, the recording medium is an optical disk.

In this example, four files are managed by main file management information and four sub files are managed by sub file management information. Further, the number of files manageable by the main file management information is smaller than the number of files recordable on an optical disk.

A recording area 101 on the optical disk has a sector structure of a predetermined length, where 2048 byte data can be recorded in each sector. Further, sector numbers are sequentially allocated to the respective sectors from the center of the disk toward the outer periphery. An access target sector is designated by using the sector number.

An anchor descriptor recording area holds an anchor descriptor 102 indicating an area where main file management information 103 is recorded. To change the recording position of the main file management information 103, the anchor descriptor 102 is rewritten, thereby the reading position of the main file management information 103 is changed. Further, in a case where plural anchor descriptors 102 are recorded in the anchor descriptor recording area, the number of rewriting operations in the anchor descriptor area can be reduced by setting such that only the last anchor descriptor 102 is referred to. Further, the file system can be applied to a so-called write-once recording system.

In a main file management area, the main file management information 103 managing the recording positions of data files recorded on the optical disk, file identifiers (file names) and the like, is recorded.

In a file recording area 104, files 1 to 3 which are AV data, PC data and the like generated by a user are recorded as files 104a to 104c.

A file 104d includes sub file management information 105 managing information on sub files 1 to 4 and sub file recording areas 106a to 106d holding the sub files 1 to 4. The sub file management information 105 and the sub files 1 to 4 are handled as one main file like files 1 to 3 on the main file system.

Data recorded on the optical disk must be properly reproduced even if the disk surface has a scratch, dirt or the like. For this purpose, error-detection code and error-correction are added to the data, and the data is recorded on the disk. Each sector data is converted to data in unit data form, and the error correction code is added to a set of plural unit data.

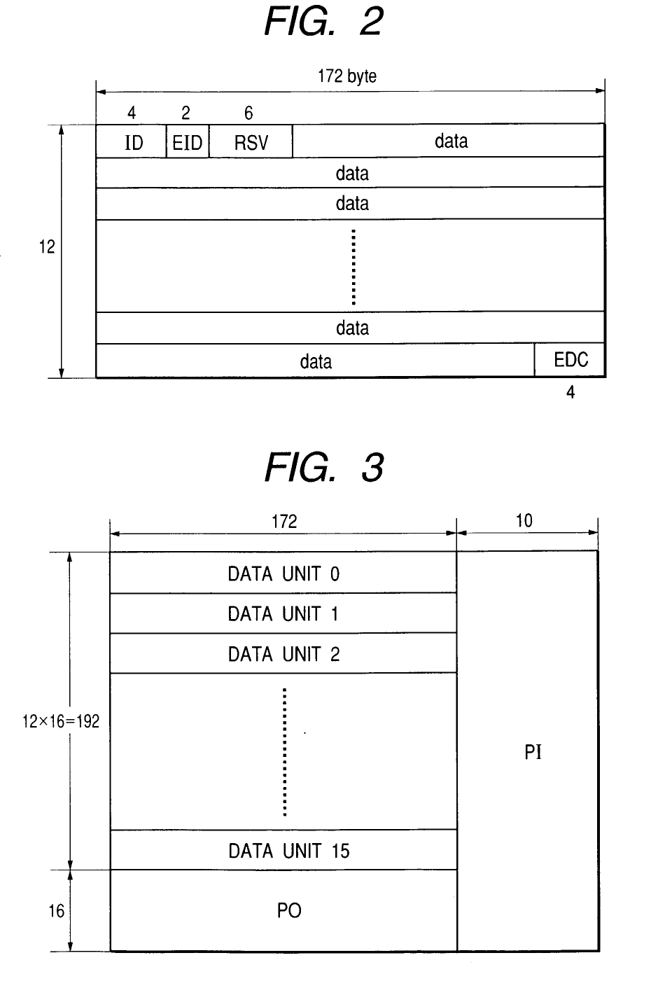

FIG. 2 shows the structure of the unit data.

Each sector has a 2048-byte data area in which the sector data is recorded. A 4-byte data identification code (ID) for data identification, a 2-byte IED as an ID error detection code, and a 6-byte RSV as spare data area, are added to the sector data, and a 4-byte error detection code EDC for data error correction is added to the end of recorded data, thereby the data unit has total 2064 bytes. Each piece of unit data is handled in the format of 172 bytes×12 lines.

FIG. 3 shows the structure of an ECC block.

An ECC block is constituted with the 172 byte×12 line data as shown in FIG. 2 for 16 sectors. In a vertical direction, a 16-byte error-correction code PO (parity outer) is added to each line. In each line, the 16-byte error-correction code is added to 192-line data (12 line×16 units), thereby the each line has 208-line data.

A 10-byte error-correction code PI (parity inner) is added to each column of data, thereby the column data has 182 bytes. The ECC block is recorded as 182 byte×208-line data on the optical disk.

Note that a CRC code (cyclic code) may be used as each error correction code. Further, a Reed-Solomon code (RS code) may be used as the error-correction code.

By the above processing, when data is recorded/reproduced on/from the optical disk, even if unreadable data occurs due to a scratch or dirt, data can be appropriately obtained by the error detection and error correction function.

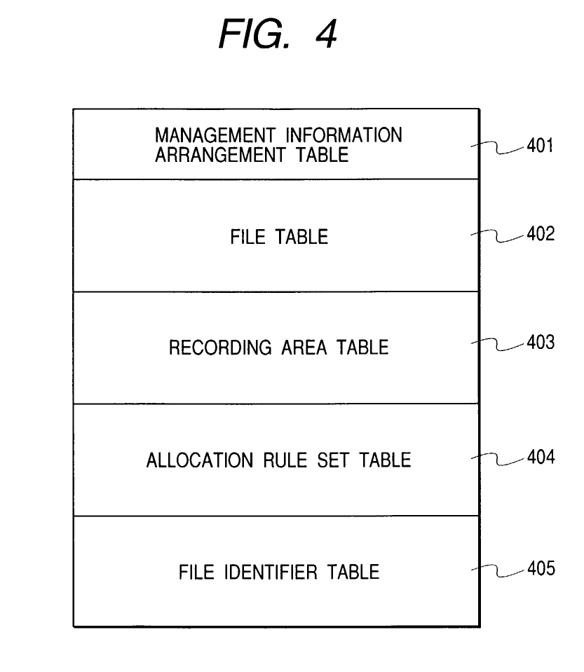

FIG. 4 shows the details of the main file management information 103 recorded in the main file management area in FIG. 1.

A management information arrangement table 401 holds arrangement information on respective tables in the main file management information. More particularly, a recording start number, presence/absence of a table continued from the table number or a continued table number, of respective tables, are recorded. The contents of the respective tables are referred to from the area arrangement information.

Among the tables, a file table 402 includes a file identifier table number corresponding to a file, link information indicating directory relation, a file attribute, a number of an extent attribute information table, a file type, file create time, file correction time and the like. The table number corresponding to each file can be obtained by referring to the file table.

A recording area table 403 includes information on recording positions of the respective files on the disk. More particularly, a recording start sector number, a recording start position, a recording end sector number, and a recording end position, of the respective files, are included. Upon reading the contents of file data, the sector number of the file data is obtained from the recording area table and data reading is performed.

An allocation rule set table 404 includes information on arrangement of divided data on the disk and the like. To continuously read data, a minimum division size upon recording of data on the disk is defined. For example, if sectors are continuously used by 4096 sectors (8 MB), a parameter “4096” is set.

A file identifier table 405 includes information on file identifier name and file identifier length. Assuming that one file identifier table has 32 byte space, if 4 bytes are allocated to the file identifier length, 28 byte data area can be allocated to the substance of the file identifier.

Note that each of the above tables has 32 byte space, however, if it has an insufficient recording area, the recorded data length can be increased by use of plural tables.

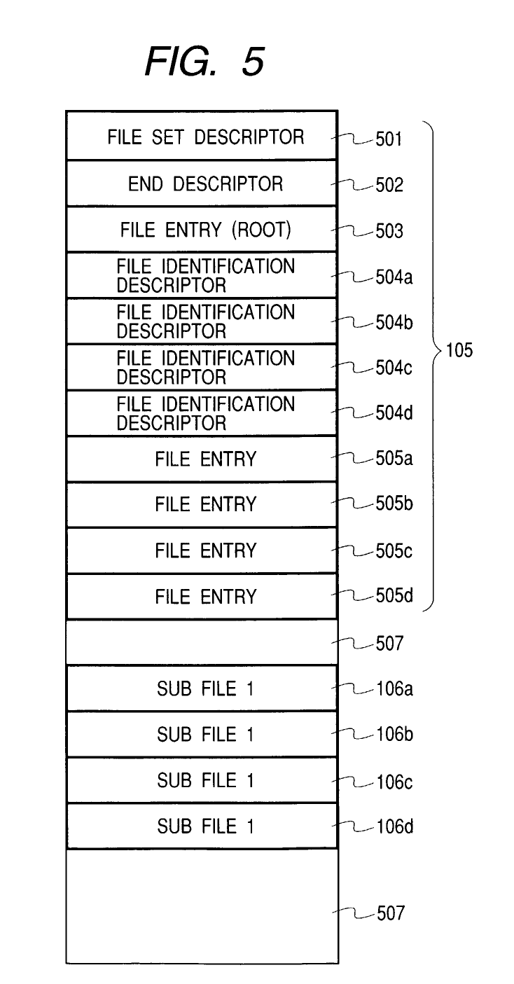

FIG. 5 shows the details of the file 104d in FIG. 1.

A file set descriptor 501, an end descriptor 502, a file entry 503, file identification descriptors 504a to 504d and file entries 505a to 505d are included in the sub file management information.

The file set descriptor 501 is detailed information on a sub file system. By use of the file set descriptor 501, the details of the sub file system can be obtained. The detailed information includes e.g. file set recording time, a volume ID for disk discrimination, and a sector number of the root file entry 503. When the sub file system is referred to, the file set descriptor 501 is first referred to for determination of the writing position of the root file entry 503.

The end descriptor 502 means that the file set descriptor does not continue any more.

The root file entry 503 is a file entry having description of root directory including detailed information on the root directory and a head sector number of file identification descriptors of files belonging thereto.

The file identification descriptor 504 has a file name and a sector number of file entry in the sub file system. A file identifier recording area corresponding to each directory holds file identification descriptors for the files belonging to the directory.

The file entry 505 has attribute information on each file such as an attribute indicating read-only, a directory or the like, a recording start sector number, a data length, and recording time.

When accessing a file, the file entry 505 of the access target is referred to from the file identification descriptor 504 in a corresponding directory, and the file is accessed from the sector number recorded in the file entry.

Note that the number of files manageable by the sub file management information 105 shown in FIG. 5 is greater than the number of files manageable by the main file management information 103.

As described above, on a main file system where the number of manageable files is less than the number of files recordable on an optical system, sub file management information is provided, and sub files are managed by the sub file management information, thereby the number of files manageable on the main file system can be increased.

Especially when the minimum recording unit of the main file system is greater than that of the recording medium, as the sub file system can be constituted in the main file, the recording area of the recording medium can be efficiently used.

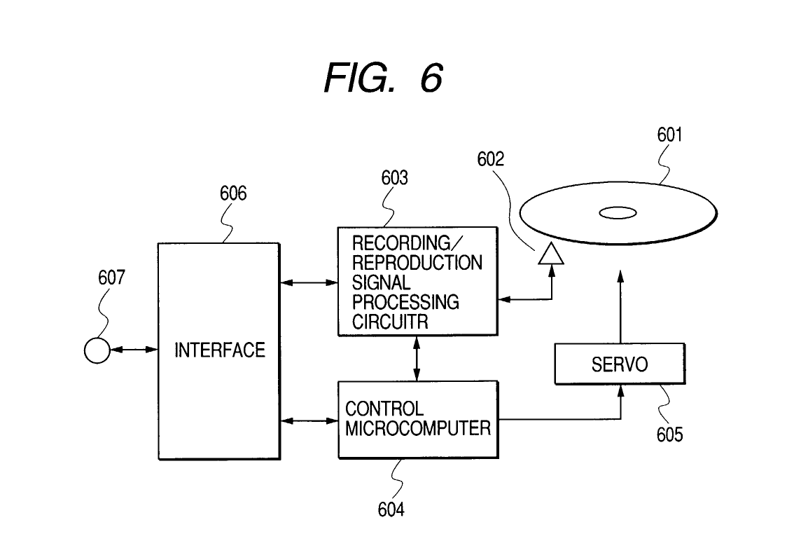

FIG. 6 is a block diagram showing a recording apparatus according to the present invention.

Information recorded on an optical disk 601 is read by an optical head 602, and demodulated by a recording/reproduction signal processing circuit 603. The demodulated data is subjected to decoding processing such as error-correction processing, and outputted as sector data via an interface 606 and an input/output terminal 607 to an external host PC (not shown) or the like. A control microcomputer 604 controls the overall recording apparatus, under instructions from the external host PC or the like, such that access to a designated sector is performed.

Upon recording, sector data is inputted from the external host PC or the like via the interface 606. The input data is subjected to coding processing such as error-correction coding by the recording/reproduction signal processing circuit 603, then subjected to modulation processing for writing onto the optical disk, and the data is written onto the optical disk 601 via the optical head 602. The control microcomputer 604 controls the overall recording apparatus, under instructions from the external host PC or the like, such that the data is written to a designated sector.

Note that a servo 605 controls turning of the optical disk, tracking processing of the optical head and the like in accordance with instructions from the control microcomputer 604.

Next, an operation of reading a file in a case where the recording apparatus merely has the main file management information but lacks sub file information will be described.

When the optical disk 601 is inserted into a disk drive device, the control microcomputer 604 detects the optical disk, and notifies the host PC of the insertion of the disk via the interface 606 and the input/output terminal 607.

The host PC receives notification of disk insertion, then first instructs reading of the anchor descriptor 102 where a sector number of the main file management information 103 is recorded.

The host PC obtains the sector number of the main file management information 103 from the anchor descriptor 102, and reads the main file management information.

The main file management information 103 has all the information on main files such as file identifiers, recording positions and directory structures and the like, as a table.

When a predetermined file is read by use of the main file management information, first, the management information arrangement table 401 is read. From the data in the management information arrangement table, a search is made through all the file tables 402 of recorded files. As each file table 402 has a file identifier table number corresponding to the file table, a file table having a file identifier table number corresponding to a file name as a reading target is found. At this time, regarding the directory, analysis is performed from the directory structure information on the file table, and the desired file table is found.

When the desired file table 402 is obtained, information on sector number and number of recording bytes of reading target file is obtained from the recording area information in the recording area table 403 corresponding to the file table. Data reading is performed from the optical disk information sector based on the obtained information.

Note that data managed by the sub file system (105 and 106) are recorded in the form of one file. That is, data managed by the sub file system has a name as one file, and information on its recording position and data length is recorded. Next, an example of data named “SUBFILES.SYS” will be described.

The data is handled as if a file “SUBFILES.SYS”, in addition to files managed by the main file system, is written in the main file management information 103. This file name is a file identifier which is usually not used in the main file system. The file identifier may be another name as long as it does not cause confusion in the main file system.

In a device corresponding to the only main file management information 103, as the “SUBFILES.SYS” file is usually not accessed, access to the sub file area does not occur. Accordingly, as there is no probability of erroneous access or deletion of data in the sub file area, the existence of the “SUBFILES.SYS” file has no influence on the main file system. That is, in a device corresponding to the only main file management information, access to files other than the “SUBFILES.SYS” file can be normally performed.

Further, since the sub file 106 and the sub file management information 105 are recorded independently of the main file system, they have no influence on the data on the main file system.

If inconvenience occurs upon access to data managed by the sub file management information in a device corresponding to the main file management information, attribute information such as “write disable”, “read disable”, “hidden file” may be added to the “SUBFILES.SYS” file in accordance with necessity. Otherwise, a flag, indicating that the “SUBFILES.SYS” file is a particular file having the sub file system, may be added to the file to the attribute information. A predetermined area in the file table 402 is allocated to the attribute information. Further, other ways of storage of the “SUBFILES.SYS” file e.g. storing the file in a particular directory may be used.

In the above-described file system, lower-order compatibility with the main file system is excellent.

Next, an operation upon access to sub file in a recording apparatus also corresponding to the sub file management information will be described.

In an apparatus also corresponding to the sub file system, first, information on recording position and length of the “SUBFILES.SYS” file is obtained by using the main file system. The acquisition of the information is made as in the case of the file search processing in the above-described device corresponding to only the main file management information.

In the example of FIG. 1, as the recording position of the sub file management information 105 is the head of the recording position of the “SUBFILES.SYS” file, the data is read from the recording start position of the “SUBFILES.SYS” file, and the contents of the data are analyzed as sub file management information.

First, basic information of the sub file system is obtained from the file set descriptor 501. Further, the sector number of root file entry is obtained from information in the file set descriptor, and the root file entry 503 is read based on the obtained sector number.

The root file entry has recording positions of file identification descriptors of files belonging to the root directory as sector numbers, and the total numbers of bytes of the file identification descriptors. The file identification descriptors are sequentially read from recording sectors of the file identification descriptors based on the obtained information.

The file identification descriptor 504 has a file identifier (file name) of file recorded in the sub file area. Accordingly, file names of files recorded in the sub file area are obtained by referring to the file identification descriptors.

The host PC searches the file identification descriptors 504 to find one corresponding with a desired file, and refers to data in the obtained file identification descriptor. In the file identification descriptor, the recording position of file entry corresponding to the file identifier is written as a sector number, in addition to the file descriptor. The host PC that has detected the file identification descriptor corresponding to the desired file name reads the file entry 505 written in the file identifier.

Next, the host PC obtains recording sector number and data length of the desired file from address information in the file entry. The data file recorded in the sub file area is read out by reading data by using the obtained sector number.

The access to a file in the sub file area can be made by the above processing. At this time, since all the file management information and data files in the sub file area are written in an area corresponding to the “SUBFILES.SYS” file, processing is completed in the sub file system, and it is not necessary to access the main file management information 103 and the main file 104 in the main file system. Accordingly, independence of the sub file system can be ensured without influence on the main file system.

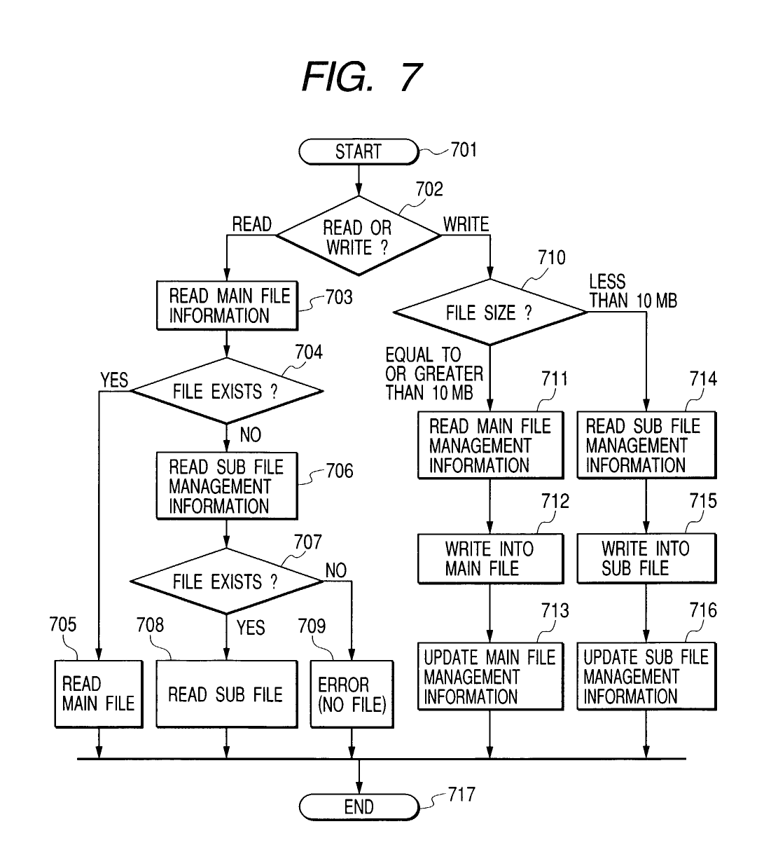

Next, a file access method will be described. FIG. 7 is a flowchart showing a processing operation by a computer program for access to a file on the above-described optical disk. The program for file access is installed in a memory of the PC (not shown).

When it is detected that the optical disk having the file structure according to the present invention is set in the apparatus in FIG. 6, a processor in the PC (not shown) is notified of the status. When the PC accesses the optical disk, the program in the memory is started, and the following processing is performed.

First, it is determined whether reading or writing is to be performed (702).

If reading is to be performed, first, the main file information is read (703), and it is checked whether or not a reading target file exists on the main file (704). A file search is performed by using a file identifier (file name), and the presence/absence of the target file is determined based on whether or not a file having the same file identifier as that of the target file exists on the file identifier table 405 in the main file management information.

If the target file is found in the main file information, the recording position information of the file is read from the recording area table 403, and the main file reading is performed (705).

If the reading target file does not exist in the main file information, the sub file management information is read (706). It is determined whether or not the reading target file exists in the file identification descriptors 504 in the sub file management information (707), and if the file exists, the recording position of the file is determined from a corresponding file entry, and sub file data is read from the sector position (708).

On the other hand, if the reading target file does not exist in the sub file management information, as the file does not exist on the disk, an error code indicating that the file does not exist is returned, and the process ends.

Next, an operation in the case of writing will be described. In this case, the process proceeds from step 702 to step 710. First, the size of file as a writing target is determined (710).

If the file size is 8 MB or larger, the file is written on the main file. More specifically, the main file management information is read (711), then an available area is determined, and the data is written as a main file into the available area on the disk (712). When the writing has been completed, information on the recording area, the identifier of the written file and the like is added to the main file management information, thereby the main file management information is updated (713).

On the other hand, if the file size is smaller than 8 MB, it is determined that the file is small (710), and the file is written as a sub file. More specifically, the sub file management information is read (714), the data is written into an available area in the sub file recording area (715). When the writing has been completed, information on the recording area, the file identifier and the like is added to the sub file management information, thereby the sub file management information is updated (716).

Data writing/reading on/from the optical disk is performed by the above processing operations Note that in the above example, the writing into the main file and the writing into the sub file are discriminated from each other by the difference of file size, however, the determination is not made only by the difference of file size. For example, the writing into the main file or the writing into the subfile may be explicitly selected by mode change. Further, the determination of file size is not necessarily made based on 8 MB as a reference size, but the value may be changed to an arbitrary size in correspondence with the apparatus or the purpose of software.

Next, processing in case of addition of sub file to an area managed by the sub file management information will be described.

In a case where a sub file is added to the sub file area, first, an available area on the disk is obtained by using the main file management information 103, and the file data is written on the disk. More specifically, the recording area table 403 corresponding to all the files in the main file management information is read, and used areas on the disk are checked.

The addition of sub file is made by adding data to the end of sub file area, however, if there is no available area at the end of the sub file area, discontinuity occurs in the sub file area, however, this does not cause a problem.

As the size of sub file area increases by that of the added sub file, the increment is reflected as increment of the “SUBFILES.SYS” file in the main file management information.

If the sub file cannot be recorded in a continuous area but is divided, plural recording areas are allocated to the recording area table of the main file management information corresponding to the recording area of the “SUBFILES.SYS” file, thereby divided sub file recording can be handled.

However, in a case where the recording area is divided into small areas, when reading the data from the optical disk, as the reading sector often changes, which takes time in seek operation. To prevent this inconvenience, it is effective to ensure a recording area on the disk by a predetermined capacity, and continuously write data in sectors in the area. For example, about 8 MB capacity may be allocated to the area. Information on data length of continuous writing is written into the allocation rule set table 404 in the main file management information.

The information on file name, data recording position, data length and the like of the recorded sub file is added to the file identifier table 504 and the file entry 505 in the sub file management information 105, thereby access to the sub file can be made.

By the above processing, the file is added to the sub file management information. At the same time, the information on the recording area is reflected in the main file management information. Accordingly, no contradiction occurs even in a device which uses only the main file management information.

Further, in a case where the size of the sub file area is reduced due to deletion of a sub file or the like, the main file management information is rewritten as change of the file size of the “SUBFILES.SYS” file, thus no contradiction occurs between the both file systems.

Note that in the above example, the sub file management information is recorded at the head of the sub file area, however, the recording position of the sub file management information is not limited to this position, and various modifications such as recording of sub file management information at the end of the sub file area can be made.

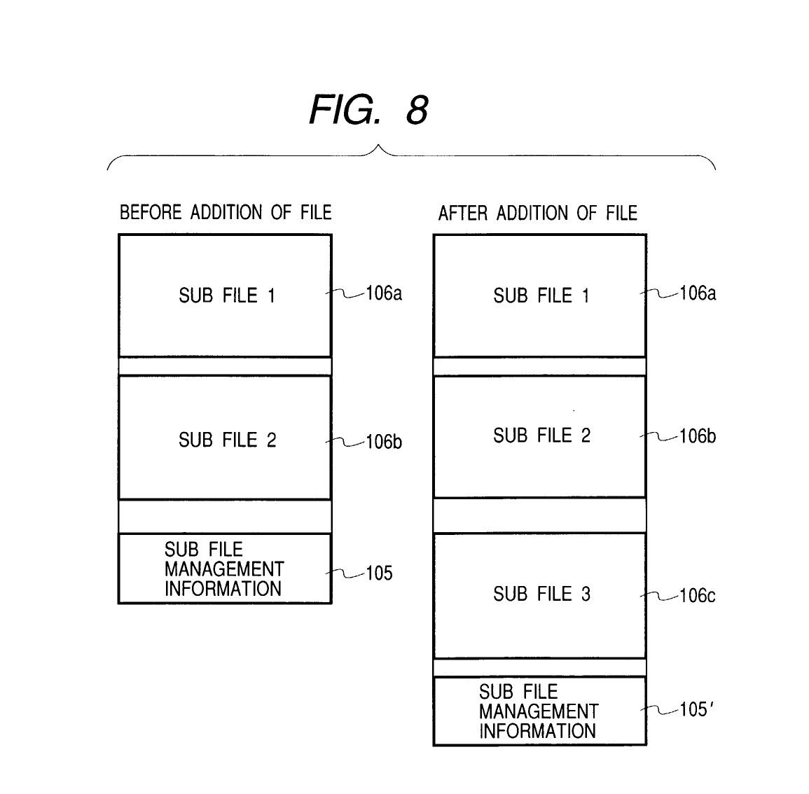

The present invention is further characterized by the position of area for the sub file management information. FIG. 8 shows an example of a file system in a case where the sub file management information is recorded at the end of the sub file area. Numeral 105′ denotes updated sub file management information.

In the recording method of the sub file management information shown in FIG. 1, the sub file management information 105 is recorded at the head of the sub file area. However, in this case, as the writing position of the sub file management area is fixed, there is a possibility that the following problem occurs.

As the writing position of the sub file management information is in front of the sub file 106, the writing area of the sub file management information is limited. In a case where a large number of sub files are added, the area for recording the sub file management information may become insufficient. Further, as rewriting is made in the sub file management information area upon each change of sub file management information, the number of rewriting operations in this area increases, thus the disk life is shortened.

Accordingly, in the recording method of the sub file management information as shown in FIG. 8, the sub file management information 105 is recorded at the end of the recording area of the sub file 106. When a file is added, the additional file (106c) is written over the area where the sub file management information has been written, and the new file management information 105′ is written behind the additional file. By this arrangement, the area in which the sub file management information is not limited. Further, as the recording area of the sub file management information changes upon each addition of file, collective data writing in particular sector(s) can be prevented.

Since sub file data and sub file management information are handled as one file on the main file management information 103, there is no information on a writing start sector of the sub file management information. Accordingly, there is a possibility that the area of the sub file management information becomes unknown.

Accordingly, the recording area 105 of the sub file management information is set as last 16 sectors of the sub file recording area (i.e. recording area of the “SUBFILES.SYS” file). As the sector number can be obtained from the information of the recording area of the “SUBFILES.SYS” file, the head position of the sub file management information can be easily obtained.

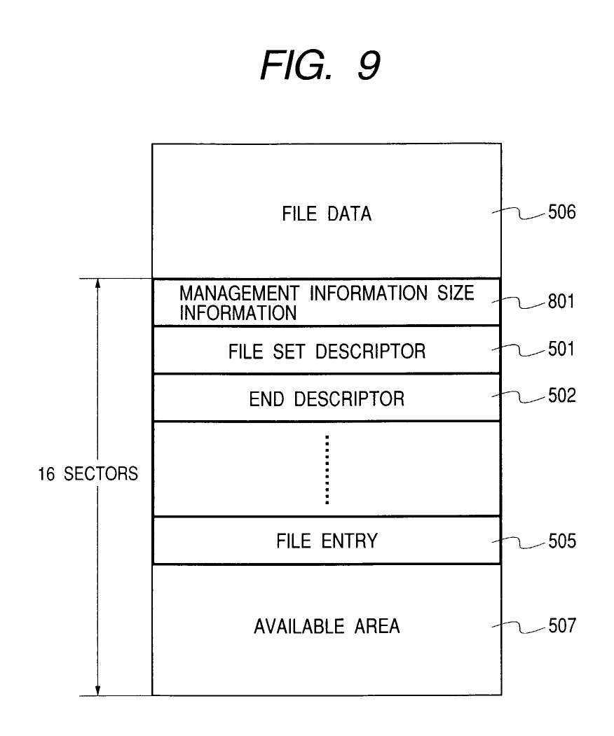

FIG. 9 shows a data arrangement in a case where the sub file management information is recorded in the last 16 sectors of the sub file area.

In FIG. 9, numeral 801 denotes management information size information.

The sub file management information is recorded in the last 16 sectors of the sub file recording area based on the size of an ECC block. That is, as error-correction processing is performed when reading sector data, if reading is performed by ECC block, reading time is shorter than a case where the data is distributed in plural ECC blocks. Further, if the sub file management information is written by ECC block, very high efficiency of writing can be attained. The number of sectors is not limited to 16; even if the sub file management information is recorded in an arbitrary position in the sub file area, sub file management can be similarly performed.

In the recording method of the sub file management information as shown in FIG. 9, the management information size information 801 is recorded at the head of the sub file management information. It is introduced for facilitation of management of the sub file management information, but is not necessarily required.

When access is made to a sub file, first, necessary reading data size is obtained from the management information size information 801, and the sub file management information (501 to 505) is read. Thereafter, access to the sub file is performed as described above.

In a case where the last 16 sectors of the sub file area are ensured as the recording position of the sub file management information, a problem further occurs when the sub file management information has a size equal to or greater than 16 sectors. In this case, it is important to study how to record the sub file management information of a size over 16 sectors.

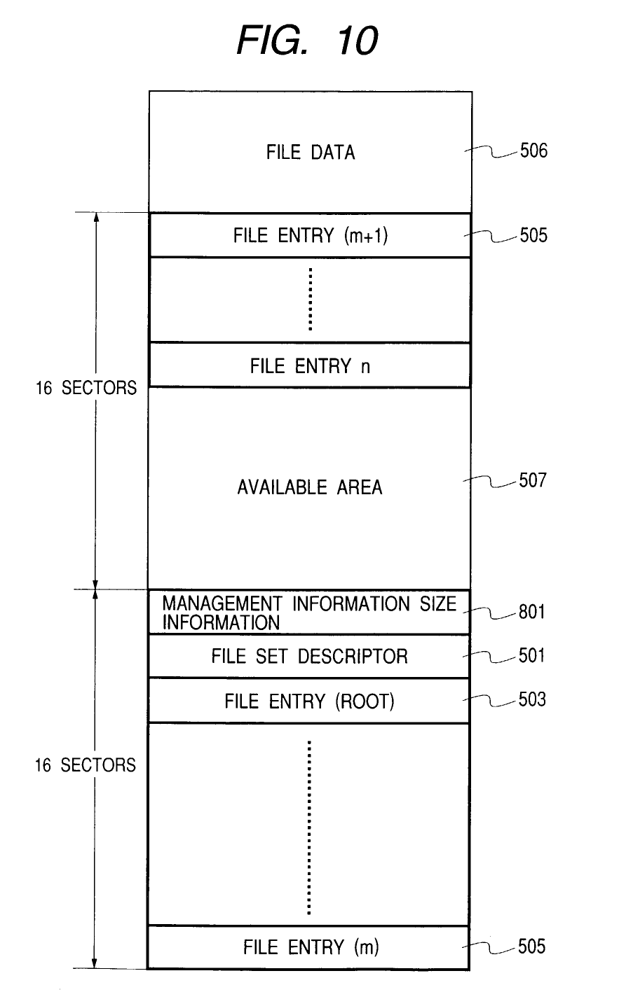

One preferable solution is to form a file structure as shown in FIG. 10. FIG. 10 shows a recording method of sub file management information of a size equal to or greater than 16 sectors.

In a case where the size of the sub file management information is greater than 16 sectors, immediately previous 16 sectors are ensured for the remaining part of the sub file management information. If the sub file management information cannot be stored within 32 sectors, another previous 16 sectors are used. By this arrangement, the sub file management information, even having a large size, can be recorded.

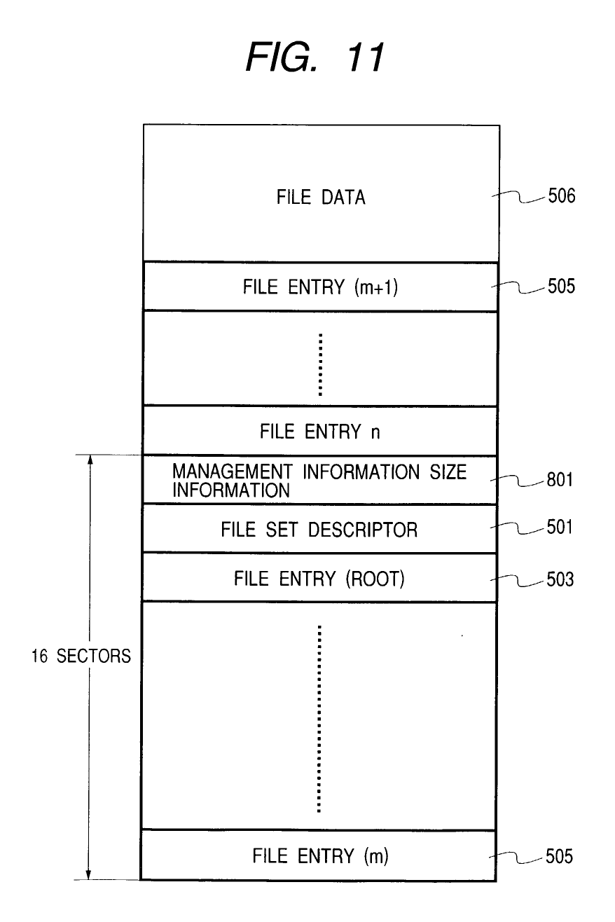

FIG. 11 shows another recording method of the sub file management information in a case where the sub file management information has a size equal to or larger than 16 sectors.

In FIG. 11, the sub file management information, from which first data for 16 sectors is removed, is recorded in the immediately previous area.

In this case, unlike the case of FIG. 10, even if the size of the sub file management information is large, it is not necessary to sequentially use the sectors backward, and therefore file access can be performed at a high speed. The size of the sub file management information except the end 16 sector data is obtained from the management information size information.

As described above, the sub file management information is recorded in the end of the sub file recording area. In this case, the recording start position of the sub file management information is always fixed to the last 16 sectors of the sub file area (i.e. “SUBFILES.SYS”), thereby reading can be easily performed. Further, the recording start position of the sub file management information can be arbitrarily determined.

In the case where the recording start position of the sub file management information is set to the end of the sub file recording area, as a further advantage, additional recording can be made on a once-recordable type optical disk called write-once disk.

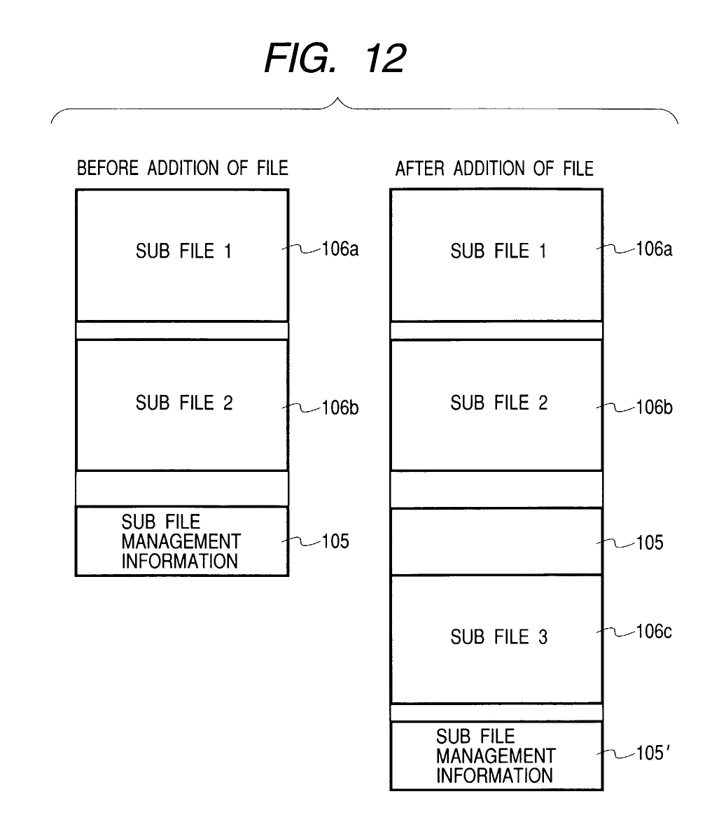

FIG. 12 shows a change in the sub file recording area upon additional description of sub file on a disk.

In a write-once type disk, as data once written on the disk cannot be deleted, the data is rewritten by additional recording processing. Further, the writing is made by ECC block.

In FIG. 11, when a sub file 3 (106c) is written, it is added to the end of the earlier sub file management information 105. At this time, as the recording start position of the sub file management information is defined as last 16 sectors of the sub file recording area, the earlier sub file management information becomes unavailable. Information on the sub file 3 is added to the earlier sub file management information thereby new sub file management information 105′ is generated, and the new sub file management information is recorded behind the sub file 3. Thus new sub file management information is automatically referred to.

Note that as the size of the sub file recording area has increased, the main file management information must be changed as if the size of the “SUBFILES.SYS” file had increased.

As described above, by introduction of sub file system, access to a sub file, addition of a sub file and the like can be performed. At this time, there is almost no influence on the main file system, and no problem occurs in compatibility with the conventional file system.

The embodiments of the present invention have been described as above, however, the present invention is not limited to the above embodiments and is applicable to various modifications, other applications and combinations with other techniques.

In the above description, the sub file management information and the sub file are handled as one main file, however, various modifications can be made regarding this point. For example, it may be arranged such that the sub file management information is generated as an independent main file, and the sub file, as another main file. In this case, these files are handled as two different files on the main file management information, however, the same advantages are obtained.

Further, it may be arranged such that the sub file management information and the sub file are provided in each directory on the main file. In this arrangement, the directories are managed by the main file management information, and files belonging to the directories are handled as sub files. In the sub file management information, it is not necessary to handle information on the directory structure. Thus the structure can be simplified.

Further, in a case where the optical disk recording/reproduction apparatus as shown in FIG. 6 is connected to a personal computer (PC), the following application can be provided. That is, it is arranged such that the optical disk recording/reproduction apparatus (first apparatus) as shown in FIG. 6 in which the optical disk having the file structure according to the present invention (first file) is accessible, and an optical disk recording/reproduction apparatus (second apparatus) in which an optical disk in conformity with the conventional format e.g. the ISO 9660 (second file) is accessible, are connected to the personal computer. In this case, it is preferable that the PC supports the both first and second file formats such that files in these optical disks are accessible. For this purpose, the PC holds a first program for access to the first apparatus and a second program for access to the second apparatus in its memory, and when an access request to one of the respective optical disks set in the recording/reproduction apparatuses occurs, starts a corresponding program to access a target file. In this case, the method of accessing the first file (first mode) is as described above with reference to FIG. 7. Further, the method of accessing the second file (second mode) is file access based on the ISO 9660 system. Note that the file structure in conformity with the ISO 9660 system lacks the sub file management area of the present invention. The file structure has a file area for storing plural files and a management area holding management information for managing access to plural files in the file area, as in the case of the conventional art.

Note that in the above example, the optical disk recording/reproduction apparatuses are connected as the separate first apparatus and second apparatus to the PC, however, the first and second apparatuses may be incorporated into one recording reproduction apparatus. In this case, the first optical disk and the second optical disk are set in the same recording/reproduction mechanism. On the assumption that the first optical disk is realized as a DVD and the second optical disk, as a CD, the disks are discriminated as follows. Since the thickness of DVD and that of CD are different, an optical pickup system is operated, and the disks are discriminated from each other by the difference in focus-achieved positions.

Further, the first file and second file may be supported not only by the PC but also by a computer system having a server.

As many apparently widely different embodiments of the present invention can be made without departing from the spirit and scope thereof, it is to be understood that the invention is not limited to the specific embodiments thereof except as defined in the appended claims.

What is claimed is:

1. A file management method for managing data in file format recorded on a recording medium, comprising:
providing first file management information and second file management information which is different from said first management information; and
handling the second file management information as a file managed by the first file management information.

2. The file management method according to claim 1, wherein among files managed by the first file management information, regarding a file in which the second file management information is recorded, an attribute indicating that the file is file management information is added to attribute information of the file.

3. The file management method according to claim 1, wherein among files managed by the first file management information, regarding a file in which the second file management information is recorded, a predetermined particular file name is given to the file.

4. The file management method according to claim 1, wherein plural files managed by the second file management information are handled as one file on the first file management information.

5. The file management method according to claim 1, wherein the second file management information and plural files managed by the second file management information are handled as one file on the first file management information.

6. A file structure for storing plural files comprising:
an anchor descriptor storage area for storing an anchor descriptor indicating information on a position of main file management information;
a main file management area for storing the main file management information on storing positions, data sizes and file names of plural main files;
a main file area for storing the plural main files; and
a sub file area, being a particular area as at least one file of the plural main files, having a sub file management area for storing sub file management information on storing positions, data sizes and file names of plural sub files and a sub file area for storing the plural sub files.

7. The file structure according to claim 6, wherein the main file management area has:
a management information arrangement table area for storing arrangement information of respective tables in the main file management area;
a file table area for storing information on table numbers of file identifiers and file attributes corresponding to the respective files;
a storage area table for storing information on storing positions of the respective files; and
a file identifier table for storing information on names and lengths of the respective file identifiers.

8. The file structure according to claim 7, wherein the main file management area further has an allocation rule set table area for storing information on distributed locations of data on a file storage area.

9. The file structure according to claim 7, wherein the file identifier table is an area for storing an identifier indicating sub file management information.

10. The file structure according to claim 6, wherein the main file area is an area for mainly storing image information, and the sub file area is an area for mainly storing document information as character codes.

11. The file structure according to claim 6, wherein the particular area as at least one file of the main files is a file structure having:
a file set descriptor area, as an area initially referred to upon sub file access, for storing at least information on a sector in which a root file entry is stored;
a root file entry area for storing at least a head sector of a file identification descriptor stored in a sub file;
a file identification descriptor area for storing file names of sub files and sector numbers of respective file entries;
a file entry area for storing file attributes of the respective sub files; and
a sub file area partitioned into plural areas for storing information, being accessed by reference to the file entry.

12. The file structure according to claim 6, wherein information managed as a sub file system is provided with a particular name so as to be handled as one file, and the name indicating a sub file is stored in the main file management area.

13. The file structure according to claim 6, wherein the sub file management area is formed at an end of the sub file area.

14. A file system for managing files formed on a storage device comprising:
a first file system having a first file area for storing plural first files and a first management area for storing first management information managing access to plural files in the first file area; and
a second file system having a second file area, using at least one file storage area in the first file area in the first file system, for storing plural second files, and a second management area for storing second management information managing access to plural files in the second file area.

15. The file system according to claim 14, wherein the file system is constructed on an optical disk,
and wherein the first management area holds management information on storing positions, data sizes and file names of the plural first files,
further wherein the second management area holds management information on storing positions, data sizes and file names of the plural second files.

16. A file access method comprising:
a first step of accessing an anchor descriptor storage area for storing an anchor descriptor indicating information on a position of main file management information;
a second step of, when designation is made at the first step, accessing a main file management area for storing management information on plural main files, and searching the main file management area;
a third step of, if a designated file is found by the main file management information as a result of search at the second step, accessing one file identified from a main file area storing the plural main files;
a fourth step of, if a particular named file is found as the result of search at the second step, accessing a sub file management area as at least one file of the plural main files for storing management information on plural sub files, and searching the sub file management area; and
a fifth step of, if a designated file is found by the sub file management information as a result of search at the fourth step, accessing one sub file identified from a sub file area storing the plural sub files.

17. An access method for accessing files in different file formats, comprising:
a first mode of accessing a first format file having:
a first file system having a first file area for storing plural first files, and a first management area for storing first management information managing access to plural files in the first file area; and
a second file system having a second file area, using at least one file storage area in the first file area in the first file system, for storing plural second files, and a second management area for storing second management information managing access to plural files in the second file area, and
a second mode of accessing a second format file having:
a third file area for storing plural third files, and a third management area for storing third management information managing access to plural files in the third file area.

18. The access method according to claim 17, wherein the second format file is formed in conformance with the ISO 9660 system.

19. The access method according to claim 17, wherein a first program for executing the first mode and a second program for executing the second mode are stored in a memory of a computer,
and wherein in accordance with an access request, the first program or the second program is executed.

20. A program operating on a computer as functions of:
first means for accessing an anchor descriptor storage area for storing an anchor descriptor indicating information on a position of main file management information;
second means for, when designation is made by the first means, accessing a main file management area for storing management information on plural main files, and searching the main file management area;
third means for, if a designated file is found by the main file management information as a result of search by the second means, accessing one file identified from a main file area storing the plural main files;
fourth means for, if a particular named file is found as the result of search by the second means, accessing a sub file management area as at least one file of the plural main files for storing management information on plural sub files, and searching the sub file management area; and
fifth means for, if a designated file is found by the sub file management information as a result of search by the fourth means, accessing one sub file identified from a sub file area storing the plural sub files.
